(19) United States
(12) Patent Application Publication
(10) Pub. No.: US 2025/0309579 A1
(43) Pub. Date: Oct. 2, 2025

(54) CONNECTOR

(71) Applicant: Yazaki Corporation, Tokyo (JP)

(72) Inventor: Hitomi Shibuya, Shizuoka (JP)

(21) Appl. No.: 19/082,660

(22) Filed: Mar. 18, 2025

(30) Foreign Application Priority Data
Mar. 28, 2024 (JP) 2024-052787

(51) Int. Cl. H01R 13/428

(52) U.S. Cl. CPC H01R 13/428

(57) ABSTRACT

A connector includes: a female connector housing; a female terminal fitting; a lance hole; and a lance. In a state in which the lance is locked to the lance hole, a horizontal surface of a locking groove of the lance comes into contact with a first wall portion of a tubular portion of the female terminal fitting, and the female terminal fitting is pressed by a pressing force based on a reaction force caused by an elastic deformation of the lance. The tubular portion is pressed against an inner wall of a terminal accommodating portion, and the horizontal surface of the locking groove is pressed against the first wall portion, so that friction is generated between the female connector housing and the female terminal fitting, and relative movement of the female terminal fitting in the terminal accommodating portion is restricted by the friction.

### CROSS-REFERENCE TO RELATED APPLICATION(S)

This application is based upon and claims the benefit of priority from prior Japanese patent application No. 2024-052787 filed on Mar. 28, 2024, the entire contents of which are incorporated herein by reference.

### BACKGROUND

### 1. Field of the Invention

The present disclosure relates to a connector used for connection of, for example, a wire harness routed in an automobile.

### 2. Description of the Related Art

As a connector in the related art, for example, a connector described in the following JP2016-207253A is known.

In a connector CN', for example, as illustrated in FIG. 7, on a bottom wall 31 of a terminal accommodating portion 30 formed inside a female connector housing 3, a lance 36 is provided in which a base end portion 361 is supported in a cantilever manner and which is formed to be elastically deformable with the base end portion 361 as a fulcrum. A locking groove 37 that is locked to an opening edge portion of a lance hole 215 opened in a first wall portion 211 of a tubular portion 21 of a female terminal fitting 2 is formed on a tip end portion 362 of the lance 36. The locking groove 37 has a horizontal surface 371 substantially parallel to the first wall portion 211 of the female terminal fitting 2 and a locking surface 372 that rises substantially vertically from the horizontal surface 371 and faces a locked surface 215a of the lance hole 215 in a terminal insertion direction. In addition, in the connector CN', the female terminal fitting 2 is fixed to the female connector housing 3 in a locked state by locking the locking groove 37 of the lance 36 to the opening edge portion of the lance hole 215.

However, in the connector CN' in the related art, a gap C1 in a vertical direction is formed in a Y direction between a second wall portion 213 of the tubular portion 21 of the female terminal fitting 2 and an upper wall 33 of the female connector housing 3, and a gap C2 in a horizontal direction is formed in a Z direction between the tubular portion 21 of the female terminal fitting 2 and an end wall portion 303 of the female connector housing 3. Therefore, in the connector CN', there is still room for improvement in that the female terminal fittings 2 may vibrate inside the female connector housing 3 when an external input is generated during traveling of a vehicle due to relative movement of the female terminal fittings 2 with respect to the female connector housing 3 caused by the gaps C1, C2.

### SUMMARY

The present disclosure has been devised focusing on such a technical problem, and an object of the present disclosure is to provide a connector in which vibration of a female terminal fitting in a terminal insertion portion of a connector housing can be prevented.

According to an aspect of the present disclosure, there is provided a connector in which a male connector and a female connector are connected, the connector including: a female connector housing having therein a terminal accommodating portion; a female terminal fitting that is to be accommodated in the terminal accommodating portion, includes a tubular portion into which a male terminal fitting provided in the male connector is inserted, and is electrically connected to the male terminal fitting by inserting the male terminal fitting into the tubular portion; a lance hole that is opened in an outer wall of the tubular portion; and a lance that is elastically supported in a cantilever manner on an inner wall of the terminal accommodating portion to protrude inward from the inner wall of the terminal accommodating portion and has at a tip end portion a locking groove lockable to an opening edge portion of the lance hole, in which: the female connector includes the female connector housing, the female terminal fitting, the lance hole and the lance; the locking groove has a horizontal surface facing an outer wall of the tubular portion and a locking surface configured to restrict movement of the female terminal fitting in an insertion direction by being locked to a locked surface of the lance hole; the horizontal surface of the lance is located on a terminal accommodating portion side with respect to the inner wall of the terminal accommodating portion in a free state; and the horizontal surface of the lance can elastically come into contact with the outer wall of the tubular portion based on a reaction force caused by elastic deformation of the lance generated by being pushed aside by the outer wall of the tubular portion when the female terminal fitting is inserted into the terminal accommodating portion in a state in which the lance is locked to the lance hole.

According to the present disclosure, in the state in which the lance is locked to the lance hole, the horizontal surface of the locking groove of the lance elastically comes into contact with the outer wall of the tubular portion of the female terminal fitting, and the female terminal fitting can be pressed by a reaction force caused by elastic deformation of the lance. Therefore, the tubular portion is pressed against the inner wall of the terminal accommodating portion, and the horizontal surface of the locking groove is pressed against the outer wall of the tubular portion, so that friction is generated between the female connector housing and the female terminal fitting, and relative movement of the female terminal fitting in the terminal accommodating portion is restricted by the friction. Accordingly, there is no possibility that the female terminal fitting vibrates due to vibration during traveling of a vehicle, and generation of abnormal noise due to such vibration of the female terminal fitting can be prevented.

Since the relative movement of the female terminal fitting in the female connector housing is restricted, relative movement between the female terminal fitting and the male terminal fitting in a state in which the female connector and the male connector are connected is restricted, and fine sliding wear between the female terminal fitting and the male terminal fitting can be prevented. Accordingly, the durability of the connector can be improved.

The female terminal fitting is fixed to the terminal accommodating portion by the reaction force caused by the elastic deformation of the lance, which is applied to the tubular portion of the female terminal fitting in the state in which the lance is locked to the lance hole. Therefore, the female terminal fitting can be appropriately held without causing an influence on an insertion force of the female terminal fitting into the terminal accommodating portion, such as an increase in the insertion force of the female terminal fitting into the terminal accommodating portion. Accordingly, the manufacturing workability of the connector can be improved.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a longitudinal sectional view of a connector according to the present disclosure;

FIG. 2 is a longitudinal sectional view of a female connector;

FIG. 3A is a perspective view of a female terminal fitting to which an electric wire is connected, and FIG. 3B is a cross-sectional view taken along a line A-A in FIG. 3A;

FIG. 4A is a perspective view of a female connector housing, and FIG. 4B is a cross-sectional view taken along a line B-B in FIG. 4A;

FIG. 5A is a perspective view of a male connector housing, and FIG. 5B is a cross-sectional view taken along a line C-C in FIG. 5A;

FIG. 6 illustrates longitudinal sectional views of the connector for illustrating an assembly process of the connector, Section (a) of FIG. 6 illustrates a state before each female terminal fitting passes through a lance, Section (b) of FIG. 6 illustrates a state in which the female terminal fitting is passing through the lance, Section (c) of FIG. 6 illustrates a state after the female terminal fitting passes through the lance, and Section (d) of FIG. 6 illustrates a state in which a male connector is connected to the female connector; and

FIG. 7 is a longitudinal sectional view of a connector in the related art.

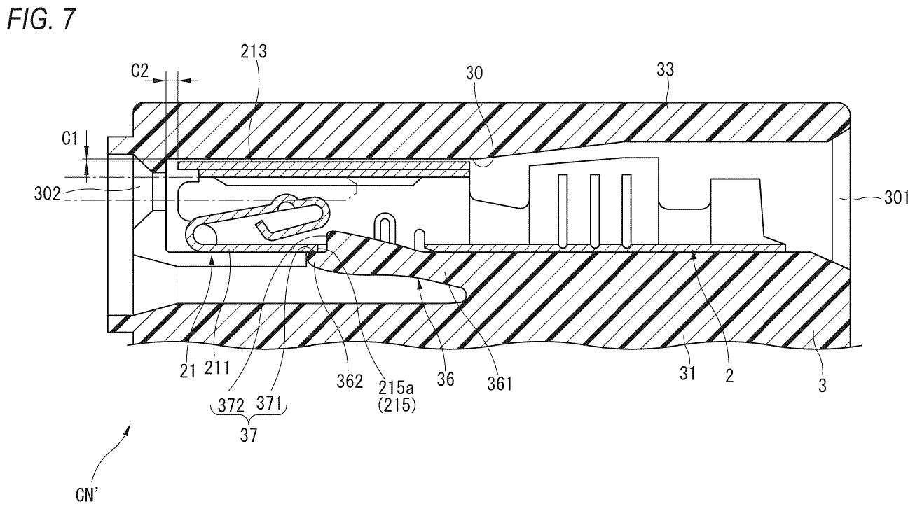

### DETAILED DESCRIPTION OF THE INVENTION

Hereinafter, an embodiment of a connector according to the present disclosure will be described in detail with reference to the drawings. In the following embodiment, an example will be described in which the connector according to the present disclosure is applied to a wire harness routed in an automobile, similarly to a connector in the related art. In the description of the drawings, a width direction of a connector CN is defined as an “X direction”, a height direction of the connector CN is defined as a “Y direction”, and an insertion direction of a female terminal fitting 2 or a fitting direction of a male connector CN2 with respect to a female connector CN1, which is a direction orthogonal to an X-Y plane, is defined as a “Z direction”. In the Y direction, a side where a lock portion RK is disposed is defined as “upper”, and an opposite side is defined as “lower”. In addition, in the Z direction, a direction in which the female connector CN1 and the male connector CN2 are fitted is defined as “front”, and an opposite side is defined as “rear”.

### Configuration of Connector

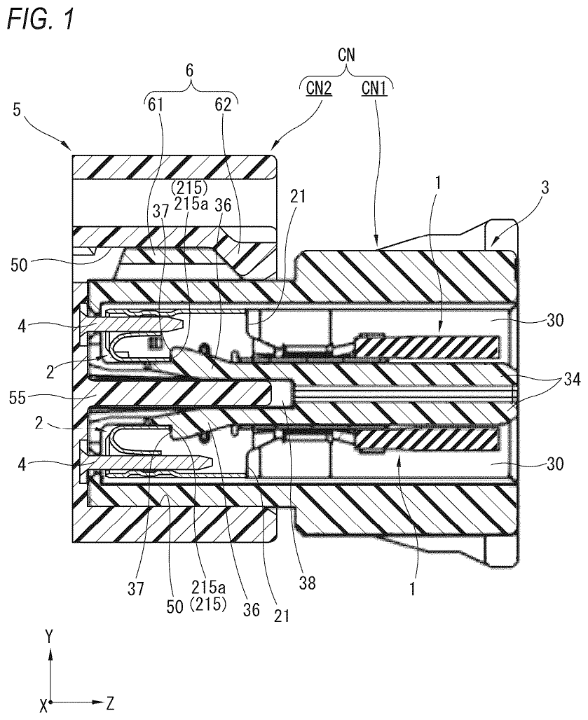

FIG. 1 is a longitudinal sectional view of the connector CN according to the present embodiment taken along the Z direction in a state in which the female connector CN1 and the male connector CN2 are fitted.

For example, as illustrated in FIG. 1, the connector CN includes the female connector CN1 and the male connector CN2. In the female connector CN1, each of female terminal fittings 2 to which an electric wire 1 is connected is accommodated and held in a terminal accommodating portion 30 penetrating the inside of a female connector housing 3 along the Z direction. In the male connector CN2, each of male terminal fittings 4 is accommodated and held in the terminal accommodating portion 50 that is opened toward a front end side along the Z direction inside a male connector housing 5.

In the connector CN, the female connector CN1 and the male connector CN2 are connected to each other by fitting a front end portion 39 of the female connector housing 3 to the terminal accommodating portions 50 of the male connector housing 5. When the female connector housing 3 and the male connector housing 5 are fitted, the male terminal fitting 4 accommodated in each of terminal accommodating portions 50 of the male connector housing 5 is inserted into the female terminal fitting 2 (tubular portion 21 described later) accommodated in each of the terminal accommodating portions 30 of the female connector housing 3, whereby the female connector CN1 and the male connector CN2 are electrically connected.

The connector CN further includes a lock portion 6 that can maintain the female connector housing 3 and the male connector housing 5 in a fitted state. The lock portion 6 includes a locked portion 61 protruding from an upper end portion of the female connector housing 3 and a locking claw portion 62 elastically supported in a cantilever manner on an upper end 513 of the male connector housing 5. That is, the locking claw portion 62 supported on the male connector housing 5, which enters from a front end side of the female connector housing 3, climbs over the locked portion 61 protruding from the female connector housing 3, and is locked to a rear end portion of the locked portion 61, so that the lock portion 6 maintains the female connector CN1 and the male connector CN2 in a connection state.

### Configuration of Female Connector

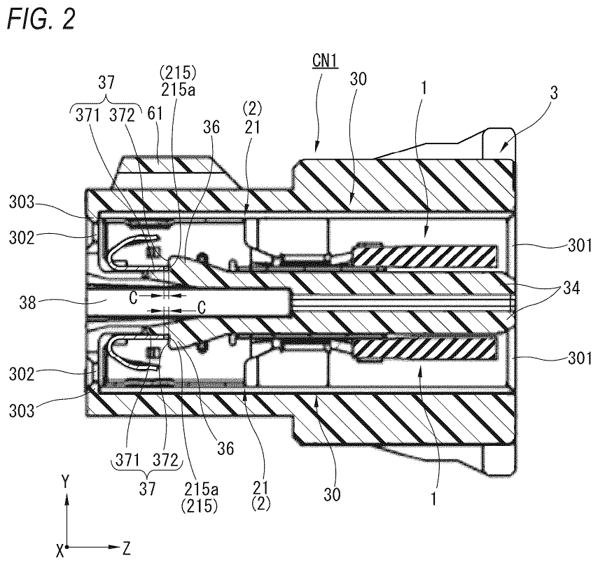

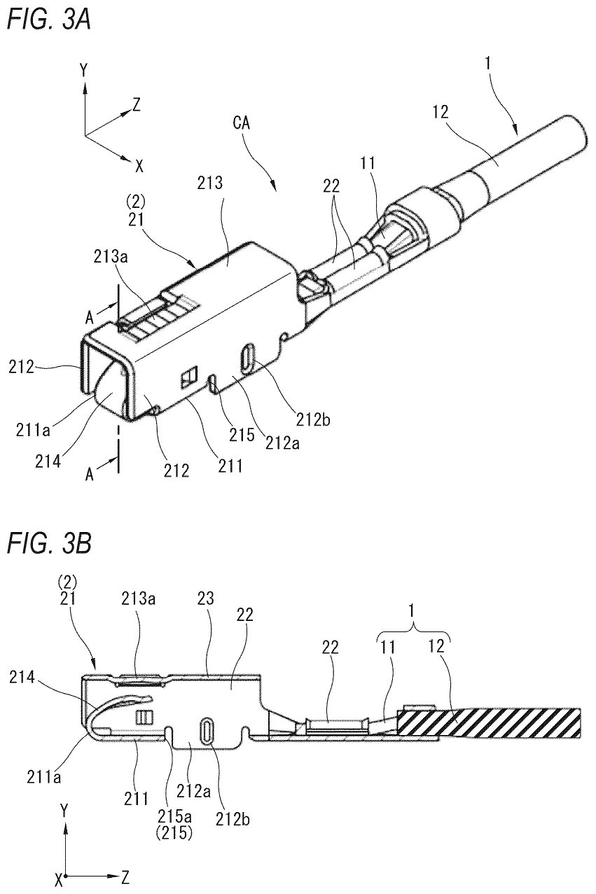

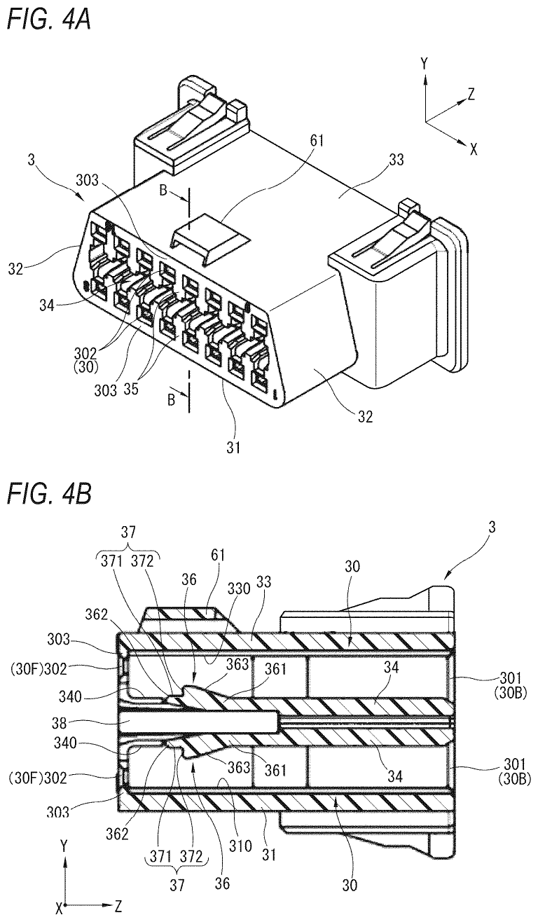

FIG. 2 is a longitudinal sectional view of the female connector CN1 taken along the Z direction. FIGS. 3A and 3B are diagrams each illustrating a cable assembly CA in which the female terminal fitting 2 is connected to a tip end portion of the electric wire 1, FIG. 3A is a perspective view of the cable assembly CA, and FIG. 3B is a longitudinal sectional view of the cable assembly CA taken along a line A-A in FIG. 3A. FIGS. 4A and 4B are diagrams each illustrating the female connector housing 3, FIG. 4A is a perspective view of the female connector housing 3, and FIG. 4B is a longitudinal sectional view of the female connector housing 3 taken along a line B-B in FIG. 4A.

For example, as illustrated in FIG. 2, the female connector CN1 includes the female connector housing 3 having therein a plurality of terminal accommodating portions 30 formed in a penetrating state along the Z direction, and female terminal fittings 2 to be accommodated in the respective terminal accommodating portions 30 of the female connector housing 3. An end of the electric wire 1 is connected to a rear end portion of the female terminal fitting 2, and the electric wire 1 and the female terminal fitting 2 are integrally formed as the cable assembly CA

For example, as illustrated in FIGS. 3A and 3B, the electric wire 1 includes a core wire 11 made of a metal and a sheath 12 made of a resin that covers the core wire 11. At the end of the electric wire 1, barrel portions 22 provided at the rear end portion of the female terminal fitting 2 is connected by crimping in a crimped state to the core wire 11 exposed by removing the sheath 12.

The female terminal fitting 2 is formed by bending a thin metal plate made of a conductive material such as copper by press molding. Specifically, the female terminal fitting 2 integrally includes the tubular portion 21 which is formed in a substantially rectangular tubular shape at a front end portion and into which the male terminal fitting 4 is inserted, and the barrel portions 22 that are provided at a rear end portion of the tubular portion 21 and are connected to the end (core wire 11) of the electric wire 1 by the crimping.

The tubular portion 21 has a rectangular tubular shape extending in a front-rear direction (the Z direction), and includes a first wall portion 211, a pair of side wall portions 212 rising substantially vertically from both side edges of the first wall portion 211, respectively, and a second wall portion 213 that connects upper end portions of the pair of side wall portions 212. That is, in the tubular portion 21, the first wall portion 211, the pair of side wall portions 212, and the second wall portion 213 constitute an outer wall of the tubular portion 21.

The first wall portion 211 is formed by overlapping both end portions of the thin metal plate when the tubular portion 21 is bent and press-molded. Further, the first wall portion 211 is provided with a contact spring 214 that is formed in a folded shape inward from a tip end of the first wall portion 211. The contact spring 214 cooperates with a terminal contact portion 213a described later to sandwich and resiliently hold the male terminal fitting 4 between the contact spring 214 and the terminal contact portion 213a (in the Y-direction). A lance hole 215 to which a lance 36 described later is locked is formed at a rear end side position of the first wall portion 211 in a penetrating state in the Y direction.

A pair of left and right stabilizers 212a extend downward at rear end positions of the pair of side wall portions 212. The stabilizers 212a are formed by cutting open a rear end side of the first wall portion 211 symmetrically on left and right sides. Further, a rib 212b formed by protruding the stabilizer 212a inward by the press molding is formed on each of central portions of the stabilizers 212a. The ribs 212b reinforce the respective stabilizers 212a.

The second wall portion 213 is provided with the terminal contact portion 213a that is formed on an inner surface of the second wall portion 213 such that the second wall portion 213 protrudes inward by the press molding. The terminal contact portion 213a comes into contact with the male terminal fitting 4 that is inserted from a tip end side of the tubular portion 21 and biased upward by the contact spring 214, and cooperates with the contact spring 214 to elastically sandwich and hold the male terminal fitting 4 (see FIG. 2).

For example, as illustrated in FIGS. 4A and 4B, the female connector housing 3 is formed in a rectangular tubular shape and is made of a synthetic resin material, and includes therein the plurality of (in the present embodiment, for example, a total of 16 terminal accommodating portions 30 in eight rows in the X direction and two stages in the Y direction) terminal accommodating portions 30 formed along the Z direction. Specifically, the female connector housing 3 integrally includes, as wall portions that define the terminal accommodating portions 30, a bottom wall 31, a pair of side walls 32 rising from both side edges of the bottom wall 31, respectively, and an upper wall 33 that connects upper end portions of both side walls 32. The female connector housing 3 includes an intermediate wall 34 and intermediate side walls 35 as inner walls that separate the terminal accommodating portions 30. The intermediate wall 34 is disposed substantially in parallel to the bottom wall 31 and the upper wall 33 and partitions the inside of the female connector housing 3 into upper and lower portions. The intermediate side walls 35 are provided to connect the bottom wall 31 and the upper wall 33 with the intermediate wall 34, and partition the inside of the female connector housing 3 at substantially equal intervals in the X direction. In the present embodiment, the intermediate wall 34 corresponds to an inner wall of a terminal accommodating portion according to the present disclosure.

The terminal accommodating portion 30 is formed in a penetrating state along the Z direction, has a female terminal insertion port 301 that is opened larger than the tubular portion 21 at a first end portion 30B corresponding to a rear end portion, which is a side from which the female terminal fitting 2 is inserted, and has a male terminal insertion port 302 that is opened smaller than the tubular portion 21 at a second end portion 30F corresponding to the front end portion opposite to the first end portion 31B in the X direction. That is, the terminal accommodating portion 30 is formed to have a substantially rectangular shape in cross section corresponding to the tubular portion 21 of the female terminal fitting 2, an inner surface 310 of the bottom wall 31 and an inner surface 330 of the upper wall 33 are cut out in a substantially flat shape from a first end portion 30B side toward a second end portion 30F side, and the first end portion 30B (female terminal insertion port 301) side is opened larger than the tubular portion 21. On the other hand, end wall portions 303 protruding inward from tip end portions of the bottom wall 31 and the upper wall 33 are formed on the second end portions 30F of the terminal accommodating portions 30, and the second end portion 30F (male terminal insertion port 302) side is opened smaller than the tubular portion 21.

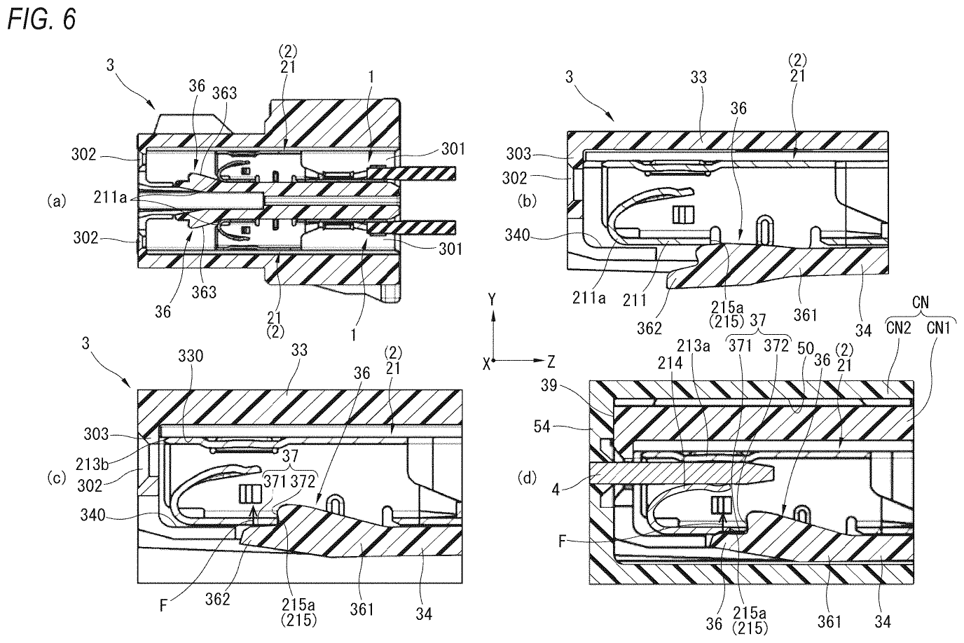

The end wall portion 303 is formed to overlap a tip end surface 213b of the second wall portion 213 of the female terminal fitting 2 in the Z direction, and is formed to be able to abut against the tip end surface 213b of the second wall portion 213 of the female terminal fitting 2 inserted into the terminal accommodating portion 30 from the female terminal insertion port 301 of the female connector housing 3. The end wall portion 303 abuts against the tip end surface 213b of the second wall portion 213 of the female terminal fitting 2, thereby regulating an insertion position (insertion amount) of the female terminal fitting 2 in the terminal accommodating portion 30. In addition, the end wall portion 303 has a protruding amount that allows the entire tip end surface 213b of the second wall portion 213 of the tubular portion 21 accommodated inside the end wall portion 303 in a state in which the tubular portion 21 is lifted by a pressing force F based on a reaction force caused by elastic deformation (flexural deformation) of the lance 36 described later (see Section (c) of FIG. 6).

A receiving groove 38 that receives an intermediate wall 55 described later of the male connector housing 5 is formed on a front end side of the intermediate wall 34, and a front end portion of the intermediate wall 34 is branched into bifurcate upper and lower portions by forming the receiving groove 38. Lances 36 that lock and fix the respective female terminal fittings 2 are provided at the front end portion of the intermediate wall 34. The lance 36 is formed integrally with the intermediate wall 34 by a base end portion 361 being connected to the intermediate wall 34, and is cut and raised to extend inward (into the terminal accommodating portion 30) in an inclined shape from the front end portion of the intermediate wall 34. That is, the lance 36 has the base end portion 361 supported on the intermediate wall 34 in the cantilever manner, and is resiliently deformable (flexibly deformable) toward a receiving groove 38 side with the base end portion 361 as the fulcrum.

In addition, the lance 36 has, between the base end portion 361 and a tip end portion 362, a guide surface 363 having an inclined shape (a tapered shape) such that a distance between the lance 36 and the inner surface 310 of the bottom wall 31 or the inner surface 330 of the upper wall 33 facing the lance 36 gradually decreases from the base end portion 361 toward the tip end portion 362. The guide surface 363 comes into sliding contact with a tip end of the female terminal fitting 2 inserted from the female terminal insertion port 301 to guide movement (elastic deformation) of the lance 36 toward the receiving groove 38.

Further, a stepped locking groove 37 formed by cutting out the tip end portion 362 of the lance 36 in an L shape is formed on the tip end portion 362 of the lance 36. The locking groove 37 is opened forward (toward a male terminal insertion port 302 side) and inward (toward a terminal accommodating portion 30 side). Specifically, the locking groove 37 has a flat horizontal surface 371 that is formed substantially parallel to the first wall portion 211 of the tubular portion 21 of the female terminal fitting 2 and a locking surface 372 that rises inward (toward a terminal accommodating portion 30 side facing the lance 36) from a rear end portion of the horizontal surface 371 and can be locked to a locked surface 215a formed at a front end portion of the lance hole 215 of the female terminal fitting 2 in the Z direction. That is, an upper end portion of the lance 36 having the locking surface 372 is inserted into the lance hole 215 and the locking surface 372 of the lance 36 is locked to the locked surface 215a of the lance hole 215, so that backward movement of the female terminal fitting 2 after the locking is restricted and the female terminal fitting 2 is locked and fixed in the terminal accommodating portion 30 of the female connector housing 3.

In the present embodiment, the lance 36 is provided such that the horizontal surface 371 is located on the terminal accommodating portion 30 side with respect to an inner surface 340 of the intermediate wall 34 in a free state. In other words, the lance 36 is provided such that substantially an entire surface of the horizontal surface 371 can elastically come into contact with the first wall portion 211 of the tubular portion 21 based on a reaction force caused by elastic deformation of the lance 36 generated by being pushed aside by the first wall portion 211 of the tubular portion 21 when the female terminal fitting 2 is inserted into the terminal accommodating portion 30 in a state in which the locking groove 37 is locked to an opening edge portion of the lance hole 215. In this way, the lance 36 can press the tubular portion 21 toward a side toward which the lance 36 is directed, that is, toward the first wall portion 211 or the second wall portion 213 facing the intermediate wall 34 in the Y direction by generating the reaction force caused by the elastic deformation of the lance 36 in the state in which the locking groove 37 is locked to the opening edge portion of the lance hole 215. At this time, the locking surface 372 of the lance 36 is separated from the locked surface 215a of the lance hole 215 in the X direction in the state in which the locking groove 37 is locked to the opening edge portion of the lance hole 215. In other words, in the X-direction, a gap C is formed between the locking surface 372 of the locking groove 37 and the locked surface 215a of the lance hole 215.

### Configuration of Male Connector

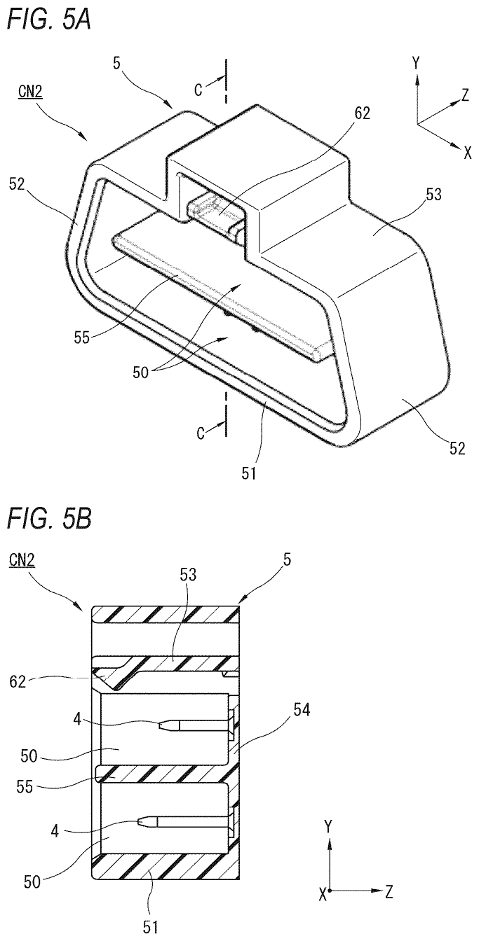

FIGS. 5A and 5B each illustrate the male connector housing 5, FIG. 5A is a perspective view of the male connector housing 5, and FIG. 5B is a cross-sectional view of the male connector housing 5 taken along a line C-C in FIG. 5A.

For example, as illustrated in FIGS. 5A and 5B, the male connector CN2 includes the male connector housing 5 having therein a plurality of terminal accommodating portions 50 that are opened toward a front end side, and male terminal fittings 4 accommodated in the respective terminal accommodating portions 50 of the male connector housing 5. Ends of electric wires (not illustrated) connected from a rear end portion of the male connector housing 5 are connected to respective rear end portions of the male terminal fittings 4.

The male connector housing 5 is formed in a rectangular tubular shape and is made of a synthetic resin material, and includes therein the plurality of (in the present embodiment, two stages in an upper-lower direction (the Y direction)) terminal accommodating portions 50 formed along the Z direction. Specifically, the male connector housing 5 integrally includes a bottom wall 51, a pair of side walls 52 rising from both side edges of the bottom wall 51, respectively, and an upper wall 53 that connects upper end portions of both side walls 52, and the front end side is opened and a rear end side is closed by an end wall 54. The male connector housing 5 includes an intermediate wall 55 as an inner wall that separates the terminal accommodating portions 50. The intermediate wall 55 is disposed substantially in parallel to the bottom wall 51 and the upper wall 53 and partitions the inside of the male connector housing 5 into upper and lower portions.

The terminal accommodating portions 50 are formed along the Z direction, are opened toward the front end side, and receive the front end side of the female connector housing 3. Further, the male terminal fittings 4 extending toward the front end side of the male connector housing 5 are provided on the end wall 54 that closes rear end portions of the terminal accommodating portions 50, and the male terminal fittings 4 are accommodated in the respective terminal accommodating portions 50.

### Method of Assembling Connector

FIG. 6 illustrates longitudinal sectional views of the connector CN for illustrating an assembly process of the connector CN, Section (a) of FIG. 6 illustrates a state before each of the female terminal fittings 2 passes through the lance 36, Section (b) of FIG. 6 illustrates a state in which the female terminal fitting 2 is passing through the lance 36, Section (c) of FIG. 6 illustrates a state after the female terminal fitting 2 passes through the lance 36, and Section (d) of FIG. 6 illustrates a state in which the male connector CN2 is connected to the female connector CN1. Hereinafter, the method of assembling the connector CN will be described with reference to FIG. 6.

First, as illustrated in Section (a) of FIG. 6, the female terminal fitting 2 is inserted from the female terminal insertion port 301 of each of the terminal accommodating portions 30 of the female connector housing 3 to a position where a tip end 211a of the first wall portion 211, which is a tip end of the tubular portion 21 of the female terminal fitting 2, comes into contact with a rear end portion of the guide surface 363 of the lance 36. Subsequently, when the female terminal fitting 2 is further pushed toward the front end side (male terminal insertion port 302 side) of the female connector housing 3, as illustrated in Section (b) of FIG. 6, the lance 36 is pushed aside toward the receiving groove 38 by the first wall portion 211 of the tubular portion 21 of the female terminal fitting 2, and the lance 36 is elastically deformed (flexibly deformed) toward the receiving groove 38 side with the base end portion 361 as the fulcrum.

Subsequently, as illustrated in Section (c) of FIG. 6, in the terminal accommodating portion 30, the first wall portion 211 of the female terminal fitting 2 passes through the lance 36, that is, a front end of the lance hole 215 passes through the locking surface 372 of the locking groove 37 of the lance 36, and the female terminal fitting 2 is inserted to a Z-direction position where the lance 36 faces the lance hole 215 of the female terminal fitting 2. Then, the lance 36 pushed aside by the first wall portion 211 of the female terminal fitting 2 moves toward the terminal accommodating portion 30 side based on the reaction force caused by the elastic deformation. Then, the horizontal surface 371 of the locking groove 37 of the lance 36 abuts against the first wall portion 211 of the female terminal fitting 2 at the opening edge portion of the lance hole 215, thereby restricting origin return of the lance 36. That is, the horizontal surface 371 of the locking groove 37 of the lance 36 elastically comes into contact with the first wall portion 211 of the female terminal fitting 2 by restricting the origin return of the lance 36 with the reaction force remaining.

In this way, the horizontal surface 371 of the locking groove 37 of each of the lance 36 elastically comes into contact with the first wall portion 211 of the female terminal fitting 2, so that the pressing force F for pressing the tubular portion 21 toward the terminal accommodating portion 30 side is applied to the female terminal fitting 2 via the horizontal surface 371 of the locking groove 37 of the lance 36, and the female terminal fitting 2 is biased (pressed) toward the terminal accommodating portion 30 (see Section (c) of FIG. 6). At the same time, the locking surface 372 of the locking groove 37 of the lance 36 faces the locked surface 215a of the lance hole 215 in the Z direction, so that the female terminal fitting 2 is locked and fixed by the respective lances 36 in the terminal accommodating portions 30. Accordingly, the female terminal fitting 2 is completely assembled into the terminal accommodating portion 30 of the female connector housing 3, and the female connector CN1 is completed.

Thereafter, as illustrated in Section (d) of FIG. 6, the male connector CN2 is fitted from a front end side of the female connector CN1. That is, the front end portion 39 of the female connector housing 3 is inserted into the terminal accommodating portions 50 of the male connector housing 5 until insertion of the male connector housing 5 into the female connector housing 3 is restricted by the front end portion 39 of the female connector housing 3 abutting against the end wall 54 of the terminal accommodating portions 50 of the male connector housing 5. Then, when the female connector CN1 and the male connector CN2 are fitted, the male terminal fitting 4 is inserted into the tubular portion 21 of the female terminal fitting 2, and the male terminal fitting 4 is elastically held in contact between the terminal contact portion 213a and the contact spring 214, whereby the female connector CN1 and the male connector CN2 are electrically connected, and the assembly of the connector CN is completed.

### Operations and Effects of Present Embodiment

As described above, in the connector CN according to the present embodiment, in particular, in the state in which the lance 36 is locked to the lance hole 215, the horizontal surface 371 of the locking groove 37 of the lance 36 elastically comes into contact with the first wall portion 211 that is the outer wall of the tubular portion 21 of the female terminal fitting 2, and the female terminal fitting 2 can be pressed by the pressing force F based on the reaction force caused by the elastic deformation of the lance 36. Therefore, the tubular portion 21 is pressed against the bottom wall 31 or the upper wall 33 that is the inner wall of the terminal accommodating portion 30, and the horizontal surface 371 of the locking groove 37 is pressed against the first wall portion 211 of the tubular portion 21, so that friction is generated between the female connector housing 3 and the female terminal fitting 2, and relative movement of the female terminal fitting 2 in the terminal accommodating portion 30 is restricted by the friction. Accordingly, there is no possibility that the female terminal fitting 2 vibrates in the terminal accommodating portion 30 due to an external input (vibration) during traveling of the vehicle, and generation of abnormal noise due to such vibration of the female terminal fitting 2 can be prevented.

Since the relative movement of the female terminal fittings 2 in the female connector housing 3 is restricted as described above, relative movement between the female terminal fitting 2 and the male terminal fitting 4 in a state in which the female connector CN1 and the male connector CN2 are connected is restricted, and fine sliding wear between the female terminal fitting 2 and the male terminal fitting 4 can be prevented. Accordingly, the durability of the connector CN can be improved.

The female terminal fitting 2 is fixed to the terminal accommodating portion 30 by the pressing force F based on the reaction force caused by the elastic deformation of the lance 36, which is applied to the tubular portion 21 of the female terminal fitting 2 in the state in which the lance 36 is locked to the lance hole 215. Therefore, the female terminal fitting 2 can be appropriately held without causing an influence on an insertion force of the female terminal fitting 2 into the terminal accommodating portion 30, such as an increase in the insertion force of the female terminal fitting 2 into the terminal accommodating portion 30, and the manufacturing workability of the connector CN can be improved.

In the present embodiment, in the state in which the lance 36 is locked to the lance hole 215, the locking surface 372 of the lance 36 is separated from the locked surface 215a of the lance hole 215 with the gap C therebetween. Therefore, when the lance 36 is locked to the lance hole 215, there is no possibility that the locking surface 372 is caught in the lance hole 215 to hinder a pressing (biasing) action of the horizontal surface 371 on the tubular portion 21. Accordingly, in the state in which the lance 36 is locked to the lance hole 215, the pressing force F based on the reaction force caused by the elastic deformation of the lance 36 can be appropriately applied to the tubular portion 21, and the relative movement of the female terminal fittings 2 in the terminal accommodating portions 30 of the female connector housing 3 can be appropriately restricted.

In the present embodiment, even when the second wall portion 213 of the tubular portion 21 protrudes, due to a gap (backlash) generated between the outer wall of the tubular portion 21 and the inner wall of the terminal accommodating portion 30, that is, a gap (backlash) generated between the first wall portion 211 and the intermediate wall 34 or a gap (backlash) generated between the second wall portion 213 and the bottom wall 31 or the upper wall 33 due to, for example, a manufacturing error of the female terminal fitting 2 and the female connector housing 3, toward the intermediate wall 34 from the end wall portion 303 of the male terminal insertion port 302 in the Y direction in the terminal accommodating portion 30 in a free state of the lance 36, the tubular portion 21 is lifted by the pressing force F based on the reaction force caused by the elastic deformation of the lance 36 in the state in which the lance 36 is locked to the lance hole 215, so that the entire tip end surface 213b of the second wall portion 213 of the tubular portion 21 can be accommodated inside the end wall portion 303. Accordingly, when the male terminal fitting 4 is inserted from the male terminal insertion port 302, there is no possibility that the male terminal fitting 4 is caught by the tip end surface 213b of the second wall portion 213 of the female terminal fitting 2, and the workability of connecting the female connector CN1 and the male connector CN2 can be improved.

The present disclosure is not limited to the configuration illustrated in the above-described embodiment, and for example, a specific shape of the female terminal fitting 2, outer shapes of the female connector housing 3 and the male connector housing 5, arrangement configurations of the terminal accommodating portions 30, 50, and a specific configuration of the lock portion 6 can be freely changed according to a specification of an application target without departing from the gist of the present disclosure.

1. A connector in which a male connector and a female connector are connected, the connector comprising:
a female connector housing having therein a terminal accommodating portion;
a female terminal fitting that is to be accommodated in the terminal accommodating portion, includes a tubular portion into which a male terminal fitting provided in the male connector is inserted, and is electrically connected to the male terminal fitting by inserting the male terminal fitting into the tubular portion;
a lance hole that is opened in an outer wall of the tubular portion; and
a lance that is elastically supported in a cantilever manner on an inner wall of the terminal accommodating portion to protrude inward from the inner wall of the terminal accommodating portion and has at a tip end portion a locking groove lockable to an opening edge portion of the lance hole, wherein:
the female connector includes the female connector housing, the female terminal fitting, the lance hole and the lance;
the locking groove has a horizontal surface facing an outer wall of the tubular portion and a locking surface configured to restrict movement of the female terminal fitting in an insertion direction by being locked to a locked surface of the lance hole;
the horizontal surface of the lance is located on a terminal accommodating portion side with respect to the inner wall of the terminal accommodating portion in a free state; and
the horizontal surface of the lance can elastically come into contact with the outer wall of the tubular portion based on a reaction force caused by elastic deformation of the lance generated by being pushed aside by the outer wall of the tubular portion when the female terminal fitting is inserted into the terminal accommodating portion in a state in which the lance is locked to the lance hole.

2. The connector according to claim 1, wherein
the locking surface is separated from the locked surface of the lance hole in the state in which the lance is locked to the lance hole.

3. The connector according to claim 1, wherein:
the tubular portion includes a first wall portion in which the lance hole is formed and a second wall portion facing the first wall portion;
the terminal accommodating portion has a female terminal insertion port that is formed on a first end portion in the insertion direction of the female terminal fitting and is opened larger than the tubular portion, and from which the tubular portion is inserted with a predetermined gap between the tubular portion and the inner wall of the terminal accommodating portion, and a male terminal insertion port that is formed on a second end portion opposite to the first end portion in the insertion direction of the female terminal fitting and is opened smaller than the tubular portion, and from which the male terminal fitting is inserted;
the male terminal insertion port has an end wall portion facing a tip end surface of the second wall portion of the tubular portion and configured to restrict an insertion position of the tubular portion by abutting against the tip end surface of the second wall portion in an inserted state of the female terminal fitting;
a part of the second wall portion of the tubular portion is located on a first wall portion side with respect to a tip end of the end wall portion based on the gap in a free state of the lance; and
the tubular portion is lifted by being pressed against the horizontal surface in the state in which the lance is locked to the lance hole, so that an entire tip end surface of the second wall portion of the tubular portion faces the end wall portion and is accommodated inside the end wall portion.
